(19) United States
(12) Patent Application Publication
(10) Pub. No.: US 2025/0210641 A1
(43) Pub. Date: Jun. 26, 2025

(54) A MOLTEN SALT PROCESS FOR THE PREPARATION OF PRE-LITHIATED LITHIUM MANGANESE-BASED OXIDES

(71) Applicant: Pacific Industrial Development Corporation, Ann Arbor, MI (US)

(72) Inventors: Bing Tan, Ann Arbor, MI (US); Yuhao Liao, Ann Arbor, MI (US)

(21) Appl. No.: 18/846,748

(22) PCT Filed: Apr. 18, 2023
(86) PCT No.: PCT/US2023/018895

§ 371 Date: Sep. 13, 2024

Related U.S. Application Data
(60) Provisional application No. 63/337,665, filed on May 3, 2022.

(51) Int. Cl. H01M 4/505; C01G 45/1242; H01M 4/36

(52) U.S. Cl. CPC H01M 4/505; C01G 45/1242; H01M 4/364; C01P 2002/50; C01P 2002/72; C01P 2006/40

(57) ABSTRACT

A process of preparing a pre-lithiated lithium manganese-based oxide product for use as a cathode active material in an energy storage device. The process includes mixing together a lithium manganese-based oxide having a spinel crystal structure. a lithium salt, and KOH to form a mixture. This mixture is exposed to a temperature within the range of 226° C. to 450° C. in the presence of a reducing agent to form the pre-lithiated lithium manganese-based oxide product. The reducing agent comprises NH₃ and the amount of lithium salt and KOH present in the mixture are in a ratio that results in at least a portion of the lithium salt being in a liquid state at the selected temperature. The KOH is removed from the pre-lithiated lithium manganese-based oxide product and the resulting product collected. An energy storage device using the pre-lithiated lithium manganese-based oxide product as a cathode active material is also provided.

### FIELD

This invention generally relates to energy storage devices, such as rechargeable batteries. More specifically, the present disclosure provides a molten salt process for the preparation of pre-lithiated lithium manganese-based oxides for use as a cathode active material in an energy storage device.

### BACKGROUND

The statements in this section merely provide background information related to the present disclosure and may not constitute prior art.

Conventional lithium ion cells used in electric vehicles generally incorporate an anode (e.g., graphite, etc.) a cathode (e.g., lithium metal oxide/phosphate, etc.) and an organic electrolyte containing LiPF₆. One issue with these conventional cells is that they may cause a fire during a thermal runaway situation, mainly resulting from the interaction between the organic electrolyte and the graphite anode. In addition, since the active graphite material used in the anode exhibits a limited amount of specific capacity (i.e., theoretical=372 mAh/g), the energy density of the cell becomes restricted. In order to improve overall safety and increase energy density, the battery industry has been interested in the development of lithium metal cells that use non-flammable electrolytes, including solid-state electrolytes. However, there are many challenges associated with the commercialization of this type of cell.

One of these challenges is the increased cost of using thin lithium foil as the anode in order to compensate for the lithium lost on the anode-side of the cell during cycling. These thin lithium foils, which are generally ≤20 micrometers (μm), are difficult and expensive to produce because of their softness and the high reactivity of lithium metal.

In order to reduce production costs, it is necessary to avoid using thin lithium metal foil and instead use an “anode-free” design. However, cells with an “anode-free” design generally lack good cycling capacity because there is not any or at least insufficient lithium to continually replenish the lithium lost on the anode-side of the cell. Therefore, a continual need exists for the development of a low-cost, “anode-free” battery that can provide lithium to the anode current collector similar to the use of thin lithium foils in order to compensate for the lithium loss that occurs during cycling.

Pre-lithiated LiMn₂O₄ (i.e., Li₁₊ₓMn₂O₄ with 0<x≤1.0) may be used as a cathode active material to pair with an anode active material having low Coulombic Efficiency at the 1^{st} cycle. With the recent emergence of new anode active materials, such as Si and SiO, there is an urgent need to use such pre-lithiated cathode active materials.

Three processes are available for the preparation of pre-lithiated LiMn₂O₄. First, pre-lithiated LiMn₂O₄ may be prepared through chemical lithiation in an organic solvent using highly reactive butyllithium dissolved in an ether solvent. The use of highly reactive butyllithium with a highly flammable, ether solvent makes this process extremely challenging for commercial utilization. Second, a solid-state process using Lil as a reducing agent at a temperature of about 460° C. may be used to prepare pre-lithiated LiMn₂O₄. However, the by-product(s) of this reaction, i.e., I₂ or LiI₃, have low boiling points and can easily be deposited onto the internal surface of the reactor. Thus, this reaction requires the use of frequent washing and extensive cleaning protocols, typically using excessive amounts of acetonitrile to wash/remove the by-product(s) from contaminating the product and for cleaning the reactor. Third, a microwave process may be used to reduce LiMn₂O₄ with tetraethylene glycol. However, this process needs substantial capital investment in large microwave equipment suitable for large-scale production, which is challenging with respect to technology, cost, and integration considerations. Therefore, there is a need to find an alternative process for the preparation of pre-lithiated lithium manganese-based oxides that is less challenging with respect to commercial viability.

### SUMMARY

This disclosure generally provides a process for the preparation of a pre-lithiated lithium manganese-based oxide product. This process comprises the steps of:
a) mixing together a lithium manganese-based oxide having a spinel crystal structure, a lithium salt, and potassium hydroxide (KOH) to form a mixture;
b) exposing the mixture to a predetermined temperature within the range of 226° C. to 450° C. in the presence of a reducing agent in order to form the pre-lithiated lithium manganese-based oxide product; wherein the reducing agent comprises ammonia (NH₃) and the amount of the lithium salt and the KOH present are in a ratio that results in at least a portion of the lithium salt being in a liquid state at the predetermined temperature;
c) removing the KOH from the pre-lithiated lithium manganese-based oxide product; and
d) collecting the pre-lithiated lithium manganese-based oxide product.

According to one aspect of the present disclosure, the pre-lithiated lithium manganese-based oxide product may be defined according to the formula F-1

Li₁₊ₓMn_{2-y}A_{y}O₄, (F-1)

wherein x is within the range of 0<x≤1.0; y is within the range of 0≤y≤0.5; and A is a metal or a combination of metals, selected from the group consisting of Co, Cr, Fe, Ir, Mo, Ni, Pd, Pr, Rh, Ti, V, Ce, Tb, Ru, and Ta. The pre-lithiated lithium manganese-based oxide product may also comprise a spinel crystal structure.

According to another aspect of the present disclosure, when y>0 the metal or combination of metals, A, includes Ni, Co, or Cr. In addition, the lithium manganese-based oxide having a spinel crystal structure in step a) may be either LiMn₂O₄ or LiMn_{1.5}Ni_{0.5}O₄ and the lithium salt may be LiOH and/or a hydrate thereof. The lithium salt and the lithium manganese-based oxide used to form the mixture in step a) may be present in a molar ratio of lithium manganese-based oxide:Li salt that is in range of about 1.0 to about 10.0.

According to another aspect of the present disclosure, the molar ratio of the lithium salt:KOH is in range of about 10.0 to about 0.1. The amount of the lithium salt and the KOH present may be in a ratio that results in all of the lithium salt being in a liquid state at the predetermined temperature.

In the process, the temperature is at least 300° C. Alternatively, the temperature may range from about 350° C. to about 400° C. The mixture is exposed to the temperature for a period of time that ranges from about 10 minutes to about 24 hours.

According to yet another aspect of the present disclosure, the reducing agent may comprise 100% ammonia by volume. Alternatively, the reducing agent may comprises ammonia mixed with an inert gas in a volume ratio of NH₃ to inert gas that ranges from 5% to 95%

The collecting of the pre-lithiated lithium manganese-based oxide product may comprise filtering, washing, and drying the pre-lithiated lithium manganese-based oxide product. In addition, the removal of residual KOH may comprise exposing the pre-lithiated lithium manganese-based oxide product to an aqueous solution.

The pre-lithiated lithium manganese-based oxide product may be dried at a temperature that ranges from about 110° C. to about 250° C. In addition, the pre-lithiated lithium manganese-based oxide product may be dried in air, an inert atmosphere, or under vacuum.

According to yet another aspect of the present disclosure, the lithium manganese-based oxide may have a spinel structure doped with at least one additional element in an amount that ranges from 0.1 wt. % to 1.0 wt. % relative to the overall weight of the lithium manganese-based oxide. This at least one additional element may be selected from the group consisting of aluminum (Al), magnesium (Mg), calcium (Ca), boron (B), nitrogen (N), and fluorine (F).

An energy storage device having a positive electrode that comprises a cathode active material that is at least partially formed of the pre-lithiated lithium manganese-based oxide product prepared as previously described and further defined herein. The cathode active material in the energy storage device may be comprised entirely of the pre-lithiated lithium manganese-based oxide product. When desirable, the cathode active material may further comprise one or more conventional cathode active materials selected from the group consisting of pristine LiMn₂O₄, LiFePO₄, LiFeₓMn_{y}PO₄ (i.e., x+y=1.0, 0.1≥x≤0.5, and 0.5≥y≤0.9), lithium nickel manganese cobalt oxides (NCM or Li-NCM), LiCoO₂, LiNi_{0.5}Mn_{1.5}O₄, and sulfur. The cathode active material may comprise a mass ratio of the pre-lithiated lithium manganese-based oxide to the conventional cathode active material that ranges from about 99:1 to about 10:90.

According to yet another aspect of the present disclosure, a positive electrode for use in an electrochemical cell is provided. This positive electrode may comprise a cathode active material that is at least partially formed of the pre-lithiated lithium manganese-based oxide product prepared as previously described above and as further defined herein.

Further areas of applicability will become apparent from the description provided herein. It should be understood that the description and specific examples are intended for purposes of illustration only and are not intended to limit the scope of the present disclosure.

### DESCRIPTION OF THE DRAWINGS

In order that this disclosure may be well understood, there will now be described various forms thereof, given by way of example, reference being made to the accompanying drawings. The components in each of the drawings may not necessarily be drawn to scale, but rather emphasis is placed upon illustrating the principles of the invention.

FIG. 1 is a flowchart of a method of forming a pre-lithiated lithium manganese-based oxide product according to the teachings of the present disclosure.

FIG. 2 is a graphical comparison of the x-ray diffraction (XRD) patterns measured for a mixture of LiMn₂O₄ and LiOH*H₂O heated in the presence of NH₃ at 350° C. and 490° C.

FIG. 3 is a graphical representation of the phase diagram of a molten salt system comprising LiOH and KOH (with the liquid border highlighted).

FIG. 4 is a graphical comparison of the x-ray diffraction (XRD) patterns measured for a mixture of LiMn₂O₄ and LiOH*H₂O heated in the presence of NH₃ at 350° C. with and without the presence of KOH.

FIG. 5 is a graphical plot of voltage as a function of specific capacity for the 1^{st} charge/discharge cycle in a cell that contains a pre-lithiated lithium manganese-based oxide as a cathode active material prepared according to the teachings of the present disclosure.

FIGS. 6A/6B are schematic representations of a cell of an “anode-free” design incorporating the pre-lithiated lithium manganese-based oxide product formed according to the process of FIG. 1 as an active cathode material.

The drawings described herein are for illustration purposes only and are not intended to limit the scope of the present disclosure in any way. It should be understood that throughout the description and drawings, corresponding reference numerals indicate like or corresponding parts and features.

### DETAILED DESCRIPTION

The following description is merely exemplary in nature and is in no way intended to limit the present disclosure or its application or uses. The present disclosure generally provides a method of synthesizing pre-lithiated lithium manganese-based oxides, which may also be referred to as Li₁₊ₓMn_{2-y}A_{y}O₄ (0<x≤1.0; 0≤y≤0.5; A=metal), without using any organic solvent. More specifically, the pre-lithiated lithium manganese-based oxide is synthesized in a solid-state process from a molten salt system, followed by washing with water.

The method of making and using the pre-lithiated lithium manganese-based oxides according to the teachings contained herein is described throughout the present disclosure using LiMn₂O₄ as the lithium manganese-based oxide having a spinel crystal structure in order to more clearly illustrate the process. One skilled in the art will understand that the process may utilize other lithium manganese-based oxide materials, such as without limitation LiMn_{1.5}Ni_{0.5}O₄, which also exhibit a spinel crystal structure without exceeding the scope of the present disclosure. The pre-lithiated lithium manganese-based oxides formed herein may be used as a pre-lithiated active cathode material in an energy storage device.

The pre-lithiated lithium manganese-based oxides prepared according to the process of the present disclosure comprise the chemical formula shown in F-1,

Li₁₊ₓMn_{2-y}A_{y}O₄, (F-1)

wherein x is within the range of 0<x≤1.0; y is within the range of 0≤y≤0.5; and A is a metal or a combination of metals, provided the pre-lithiated lithium manganese-based oxide comprises a spinel crystal structure. Alternatively, x is within the range of 0.1≤x≤1.0. Alternatively, y is within the range of 0.1≤y≤0.5. The metal, A, may be selected from the group comprising, consisting of, or consisting essentially of cobalt (Co), chromium (Cr), iron (Fe), iridium (Ir), molybdenum (Mo), nickel (Ni), palladium (Pd), praseodymium (Pr), rhodium (Rh), titanium (Ti), vanadium (V), cerium (Ce), terbium (Tb), ruthenium (Ru), tantalum (Ta), or a combination thereof; alternatively, nickel, cobalt, or chromium; alternatively, nickel. Thus, several examples of a pre-lithiated lithium manganese-based oxide according to formula F-1 that comprise a spinel crystal structure include, but are not limited to, Li₁₊ₓMn₂O₄ (0<x≤1.0) wherein y=0 and Li₁₊ₓMn_{1.5}Ni_{0.5}O₄ (0<x≤1.0) wherein A=Ni and y=0.5.

The incorporation of greater than 0% up to 100% of an excess amount of lithium in the pre-lithiated active cathode material, alternatively, about 10% to 100%, changes the crystal structure of the lithium manganese-based oxide from spinel to tetragonal, which can be converted back to spinel during cycling. If the lithium content in the pre-lithiated active cathode material is too high (i.e., x>1.0 in formula F-1), a non-tetragonal crystal phase will be formed that cannot be easily converted back to a spinel crystal phase during charging and the reversible capacity of the energy storage device or cell will be reduced.

For the purpose of this disclosure, the terms “about” and “substantially” as used herein with respect to measurable values and ranges refer to the expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one metal”, “one or more metals”, and “metal(s)” may be used interchangeably and are intended to have the same meaning.

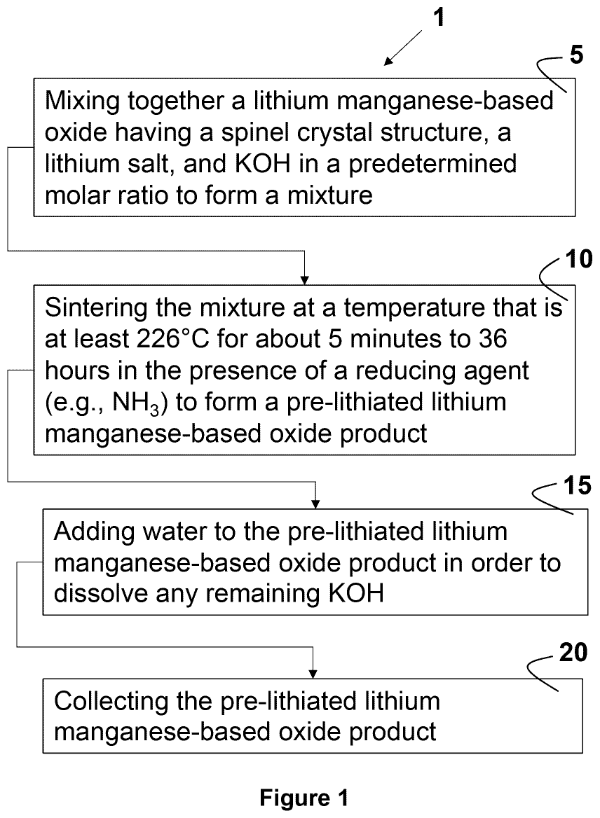

Referring now to FIG. 1, this method 1 generally comprises mixing 5 a lithium manganese-based oxide having a spinel crystal structure (e.g., LiMn₂O₄) with a lithium salt and potassium hydroxide (KOH) in a predetermined molar ratio. Since all of these starting materials are solids in nature at room temperature the step of mixing them together may involve grinding, pulverizing, mashing, or the like until the resulting components are thoroughly mixed or blended; alternatively, homogenously mixed. As previously discussed above, hereafter the process is described in the context of utilizing LiMn₂O₄ as the lithium manganese-based oxide having a spinel crystal structure in order to more clearly illustrate the process.

The mixture is then sintered 10 at a predetermined temperature ranging from at least 226° C. to about 450° C. in the presence of a reducing agent (e.g., NH₃) for about 5 minutes to about 36 hours to form the pre-lithiated LiMn₂O₄ or Li₁₊ₓMn₂O₄ (0<x≤1.0). Water is then added 15 to the pre-lithiated LiMn₂O₄ in order to dissolve any potassium hydroxide that may still be present, e.g., remove the KOH from the product. The pre-lithiated LiMn₂O₄ is then collected 20. This collection may comprise one or more of filtering, further washing, and drying. The collection 20 of the pre-lithiated LiMn₂O₄ may be performed in air or under an inert atmosphere, such as nitrogen (N₂) for example. By slightly varying the LiMn₂O₄/lithium salt ratio used in this process, a Li₁₊ₓMn₂O₄ (0<x≤1.0) product with various x values may be obtained. Since there is no highly flammable, organic solvent used in this process, this process may be considered to be safe.

Still referring to FIG. 1, the ammonia (NH₃) used in the process 1 acts as a reducing reagent to reduce the manganese (Mn) from its oxidation state of +3.5 present in the spinel LiMn₂O₄ to the oxidation state of +3.0 present in tetragonal Li₂Mn₂O₄. One skilled in the art will understand that one or more other reducing reagents may be used alone or in combination with the ammonia, provided they are compatible with each other, as well as with the other materials used in the process, and can provide the same function of reducing the oxidation state of the manganese. An inert gas, such as nitrogen (N₂) or argon (Ar) is known to be used as a mild reducing reagent for metal oxides at high temperatures. However, such inert gases are not conducive for use in this same capacity when the temperature is more moderate, i.e., in the range from at least 226° C. to 450° C. as used in the process 1 of the present disclosure.

According to another aspect of the present disclosure, the ammonia may be present as a pure gas or when desirable may be mixed with other gases, including but not limited to nitrogen (N₂) and/or argon (Ar), in order to reduce cost and to adjust the length of time associated with heating at the predetermined moderate temperature. When a gas mixture, such as for example, NH₃/N₂, is used, the NH₃ mass ratio may range from less than 100% to 1%; alternatively, from about 99% to about 5%; alternatively, from about 95% to about 10%.

A lithium salt is used to provide the lithium ions in the pre-lithiation process 1. In other words, any lithium salt may be utilized that is capable of lithiating the lithium manganese-based oxide (LiMn₂O₄, etc.), e.g., forming a brownish powder, in the process of the present disclosure under the conditions defined above and as further described herein. For example, the lithium precursor may include, but not be limited to, LiOH and/or the hydrate thereof, i.e., LiOH*H₂O. One skilled in the art will understand that other lithium salts may be used without exceeding the scope of the present disclosure, as long as the lithium salt can form a molten salt solution with KOH within the temperature range as further defined herein. Several salts, such as lithium acetate, lithium nitrate, and lithium carbonate, are excluded from the definition of the lithium precursor because in the process and under the conditions described in the present disclosure, the lithium manganese-based oxide (LiMn₂O₄, etc.) powder is not lithiated, e.g., the powder appears to remain black in color.

In order to facilitate the lithiation reaction of the lithium manganese-based oxide (LiMn₂O₄, etc.) in the presence of NH₃, the formation of a molten salt solution is desirable in order to dissolve the lithium salt (e.g., LiOH) in the temperature range of at least 226° C. to about 450° C. In the absence of a molten salt solution, the reaction between the lithium salt particles and the lithium manganese-based oxide (LiMn₂O₄, etc.) particles is limited and the resulting lithiation content added to the lithium manganese-based oxide (LiMn₂O₄, etc.) will be very low. In order to increase the reaction rate, it is desirable that at least a portion of the lithium salt becomes a liquid, thereby, significantly increasing the contact area between the lithium salt and the lithium manganese-based oxide (LiMn₂O₄, etc.), thereby, enabling the production of the desired pre-lithiated lithium manganese-based oxide product, e.g., the Li₁₊ₓMn₂O₄ (0<x≤1.0) product.

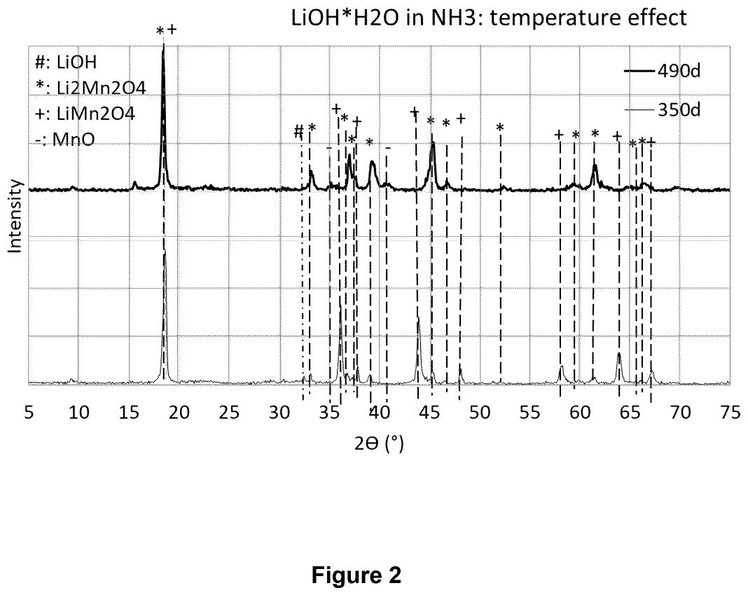

When LiOH is used as the lithium salt, it is possible to facilitate the transition of solid LiOH into a liquid state by raising the reaction temperature above its melting temperature (i.e., ≥477° C.). However, at this high temperature, at least a portion of the LiMn₂O₄ is reduced in an ammonia environment to MnO and/or Mn₃O₄ having manganese in an oxidation state of <+3. This occurrence is demonstrated in FIG. 2, which provides a comparison of the x-ray diffraction (XRD) patterns measured for a mixture of LiMn₂O₄ and LiOH*H₂O heated in NH₃ to (a) 350° C., which represents a temperature below the melting point of the LiOH*H₂O and (b) 490° C., which represents a temperature above the melting point of the LiOH*H₂O. After heating the mixture to 350° C. the collected powder was observed to be primarily black intermixed with white particles, thereby, indicating that the LiOH particles (i.e., white) did not melt. The black color of the collected product also indicates that the LiMn₂O₄ particles (i.e., black) were not reduced. If the lithium had been reduced the product would have been a brownish to greenish color associated with pre-lithiated LiMn₂O₄. The XRD pattern measured for the product obtained at 350° C. demonstrates that a majority of the crystals are spinel LiMn₂O₄ with high peak intensities. There are minor peaks in the XRD pattern that may be attributed to tetragonal Li₂Mn₂O₄, however the intensities of these peaks are substantially lower as compared to the peaks arising from LiMn₂O₄. Moreover, the crystal peak from LiOH was identified for the sample heated at 350° C. Thus, if at least a portion of the LiOH does not melt, the amount of lithiation that occurs is insignificant and does not result in the formation of any useful amount of pre-lithiated LiMn₂O₄.

In comparison, at 490° C., the LiOH peak disappeared in the measured XRD pattern as shown in FIG. 2 and the peak intensities attributed to Li₂Mn₂O₄ became much stronger. In addition, no peaks from spinel LiMn₂O₄ are observed to be present in the XRD pattern, indicating that all of the LiMn₂O₄ had been reduced. However, two impurity peaks are also observed in the XRD pattern (at ˜35° and ˜41°), which may be attributed to the presence of MnO. These impurity peaks demonstrate that a temperature above the melting point of the LiOH is too high of a temperature for the effective synthesis of Li₂Mn₂O₄. More specifically, in this case, some of the manganese is reduced to an oxidation state less than +3, thereby, indicating the formation of MnO or Mn₃O₄, instead of an oxidation state of +3, which is necessary to form Li₂Mn₂O₄. In order to avoid the deep reduction in the oxidation of manganese to less than +3, it is necessary for the reaction temperature to be substantially less than 490° C. The presence of MnO or Mn₃O₄ is not desirable when the material is intended to be used as an active cathode material. Therefore, a dilemma exists for the lithiation reaction of LiMn₂O₄ when using LiOH or LiOH*H₂O as the lithium salt.

On the one hand, the reaction temperature should be kept substantially less than 477° C. in order to avoid the formation of MnO and/or Mn₃O₄ in entirety or as a by-product. A temperature of about 450° C. is low enough that the formation of MnO and/or Mn₃O₄ is minimized. On the other hand, LiOH or LiOH*H₂O should be in a liquid or molten state (melting point ≥477° C.) in order to facilitate or accelerate the lithiation reaction. This technical dilemma is solved by the use of a molten salt system that comprises LiOH or LiOH*H₂O along with potassium hydroxide (KOH) as a co-salt. Potassium hydroxide has a melting temperature of 403.9° C.

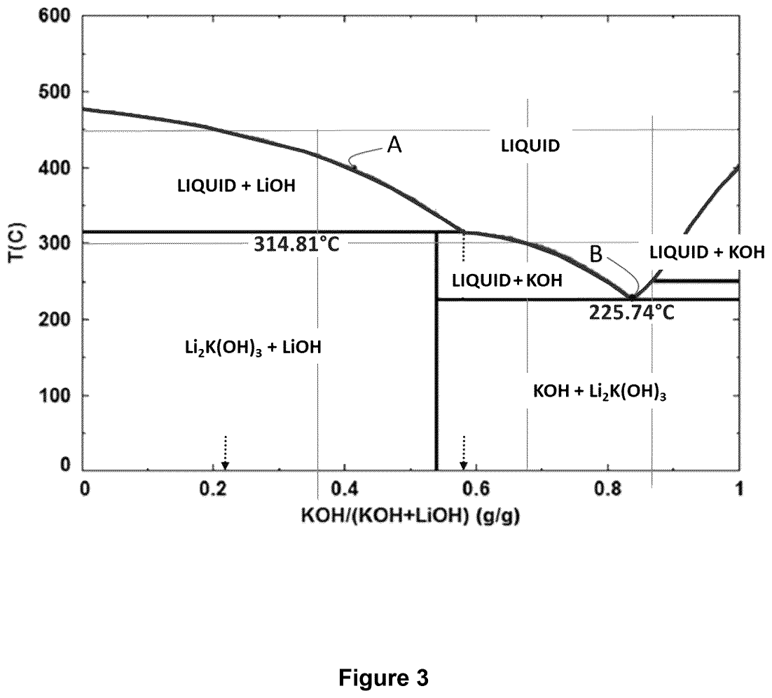

Referring now to FIG. 3, the melting temperature associated with a mixed salt system comprising LiOH and KOH are lower than the melting temperature of the pure or individual salts of LiOH or KOH. When the mass ratio of KOH/(KOH+LiOH) is at about 0.4 or the molar ratio of LiOH/KOH is at about 3.5, the melting temperature is close to 400° C. (see point A in FIG. 3). When the mass ratio of KOH/(KOH+LiOH) is at about 0.85 or the LiOH/KOH molar ratio is at about 0.4, the melting temperature of the mixed salts becomes 226° C. (see point B in FIG. 3). Thus, the temperature of the lithiation reaction may occur at a temperature that is greater than or equal to 226° C. provided the molar ratio of LiOH/KOH is such that at least a portion of the LiOH used for the lithiation reaction is present in a liquid state. One skilled in the art will understand that within this molten salt system, the LiOH may be replaced with LiOH*H₂O in order to provide lower cost and the trend will remain the same.

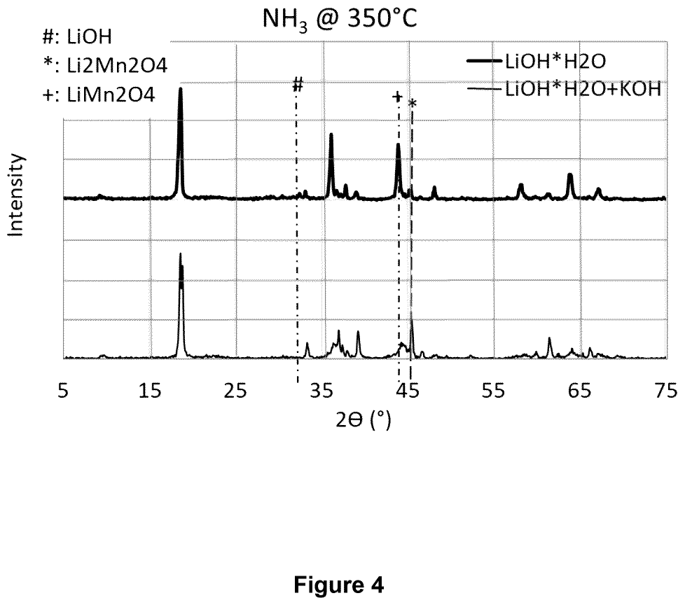

Referring now to FIG. 4, a comparison of the XRD pattern measured for two samples heated in NH₃ at 350° C. is provided. The first sample represents a mixture of LiMn₂O₄ and LiOH*H₂O, while the second sample is a mixture of LiMn₂O₄, LiOH*H₂O, and KOH. The second sample (i.e., with the KOH) is washed with water after the heating step is conducted. The XRD pattern measured for this second sample exhibits only peaks attributed to LiMn₂O₄ and Li₂Mn₂O₄ after being washed with water. The peak intensity ratio between the Li₂Mn₂O₄ (e.g., peak at 44.5°) and the LiMn₂O₄ (e.g., peak at 43.9°) crystal phases was much larger for the second sample (i.e., with the KOH), confirming that much more Li₂Mn₂O₄ has been produced with the KOH even though both the first and second samples were heated to the same temperature.

Although not wanting to be strictly held to theory, it is believed that the reduction reaction that occurred in the second sample (i.e., with the KOH) gives rise to a greater degree of lithiation than the reduction reaction that took place in the first sample because of the formation of a molten salt system. The formation of a liquid from the LiOH in the molten salt system of the second sample increases the interface area between the LiOH and LiMn₂O₄ particles as compared to the mixture of solid LiOH particles and LiMn₂O₄ particles present in the first sample. Thus, a greater amount of lithiation occurs in the second sample as compared to the reaction that occurs in the first sample. The KOH is subsequently removed from the formed product by exposure to an aqueous medium.

In summary, according to one aspect of the present disclosure, the molten salt process for the synthesis of pre-lithiated lithium manganese-based oxides uses a lithium salt and KOH as the co-salt. In this process, the amount of the lithium salt, e.g., LiOH or LiOH*H₂O, can be adjusted to make the Li₁₊ₓMn_{2-y}A_{y}O₄ (0<x≤1.0; 0≤y≤0.5; A=metal) with various Li contents. When using various amount of the lithium salt, e.g., LiOH or LiOH*H₂O, the amount of KOH is also adjusted accordingly to ensure that at least a portion of the lithium salt melts to form a molten salt solution at the predetermined reaction temperature. This predetermined reaction temperature is less than the melting point of LiOH (i.e., <477° C.) and higher than 226° C. The gas environment to which the molten salt solution is exposed is reducing by nature, e.g., with NH₃ used as the reducing reagent. The time-period over which the reaction occurs is determined based on the predetermined temperature that is selected for use.

Referring once again to FIG. 1, the KOH used as the co-salt in forming the binary salt system needs to be removed 15 from the pre-lithiated lithium manganese-based oxide product, e.g., the Li₁₊ₓMn₂O₄ (0<x≤1.0) product. In order to remove the residual KOH, the pre-lithiated lithium manganese-based oxide product may be exposed to water, e.g., washed with water. Removal of the KOH is necessary and/or desirable before the pre-lithiated product can be used as an active cathode material in a battery.

The molten salt process used for the preparation of pre-lithiated lithium manganese-based oxides utilizes a predetermined process temperature that ranges from at least 226° C. to less than 477° C., e.g., to about 450° C., alternatively, at least 300° C.; alternatively, from about 300° C. to about 425° C., alternatively, from about 350° C. to about 400° C., provided that the ratio of the lithium salt (e.g., LiOH) and the KOH are selected, such that at least a portion of the lithium salt is a liquid at the predetermined temperature. Alternatively, at least 25% of the lithium salt by weight is a liquid; alternatively, at least 50 wt. % of the lithium salt is a liquid; alternatively, at least 75 wt. % of the lithium salt is a liquid; alternatively, all of the lithium salt is a liquid at the predetermined temperature.

The period of time that the mixture of the lithium manganese-based oxide (LiMn₂O₄, etc.), lithium salt, and KOH is exposed to the process temperature may range from a few minutes to tens of hours, alternatively, from 5 minutes to about 36 hours, alternatively from about 10 minutes to about 24 hours, alternatively, from about 14 hour to about 24 hours. Generally, the time-period will be shorter with the use of a higher temperature.

In general, the molar ratio between the lithium manganese-based oxide (LiMn₂O₄, etc.) and the lithium salt (e.g., LiMn₂O₄:LiOH) used in the process of the present disclosure is in the range of 1.0 to 10.0. The molar ratio of the lithium precursor to the lithium manganese-based oxide (e.g., LiOH:LiMn₂O₄) may alternatively, range from about 2.0 to about 9.0, alternatively, from about 3.0 to about 8.0, alternatively, from about 4.0 to about 7.0.

The lithium manganese-based oxide (LiMn₂O₄, etc.) that is utilized as a starting material in the reaction process according to the present disclosure may be prepared according to one or more separate processes. Thus, the lithium manganese-based oxide (LiMn₂O₄, etc.) may exhibit various morphologies, properties, and variations in overall composition. For example, the lithium manganese-based oxide (LiMn₂O₄, etc.), without limitation, may exhibit a spherical shape with an average particle size (D₅₀) that is in the range of about 0.1 micrometer (μm) to about 100 micrometers (μm), alternatively, about 1 μm to about 30 μm. Alternatively, the lithium manganese-based oxide (LiMn₂O₄, etc.) may exhibit an irregular shape with an average particle size (D₅₀) that is in a similar range as described above without exceeding the scope of the present disclosure.

When desirable, the lithium manganese-based oxide (LiMn₂O₄, etc.) may also be doped with one or more additional metal and/or nonmetal elements or coated with various compositions containing such additional metal and/or nonmetal elements. More specifically, the lithium manganese-based oxide (LiMn₂O₄, etc.) may be doped or coated with at least one element selected from a group of aluminum (Al), magnesium (Mg), calcium (Ca), boron (B), nitrogen (N), and fluorine (F). The additional metal or nonmetal elements may be present in an amount ranging from 0.1 wt. % to about 10 wt. %, alternatively, from about 1 wt. % to about 5 wt. % relative to the overall weight of the LiMn₂O₄.

Once the reaction is completed, the pre-lithiated lithium manganese-based oxide product, i.e., the Li₁₊ₓMn₂O₄ (with 0<x≤1.0) product may be collected via various or different routes. According to one route, the product may be collected by filtering and washing the as-collected wet material with an organic solvent or water. The washed material is then dried in air to remove any liquid. According to another route, the product may be collected by heating the as-collected wet material in an oven. According to yet another route, the product may be collected by heating the as-collected wet material in air at a temperature ≥110° C., alternatively, about 200° C. In yet another route, the product may be collected by heating the as-collected wet material in an inert gas environment at a temperature that is in the range of 100° C. to 250° C., alternatively, about 200° C. The as-prepared pre-lithiated lithium manganese-based oxide product is relatively stable in the presence of water or moisture. Thus, water or organic solvents having a relatively high moisture level may be used for the washing of the pre-lithiated product. All of the collection processes may be performed in air without the need to restrict or control humidity.

The pre-lithiated lithium manganese-based oxide product may be used alone as the active cathode material or it may be used in combination with another active cathode material. Several examples of such conventional active cathode materials include, without limitation, pristine LiMn₂O₄, LiFePO₄, LiFeₓMn_{y}PO₄ (i.e., x+y=1.0, 0.1≥x≤0.5, and 0.5≥y≤0.9), lithium nickel manganese cobalt oxides (NCM or Li-NCM), LiCoO₂, LiNi_{0.5}Mn_{1.5}O₄, and sulfur. When the pre-lithiated cathode material is used in combination with another active cathode material, the mass ratio of the pre-lithiated material to the other, e.g., conventional, material may range from about 99:1 to about 10:90 depending on the application requirements. Alternatively, the mass ratio for pre-lithiated material to the conventional or other active material is greater than 100:0 and less than or equal to 10:90; alternatively, between about 90:10 and 20:80; alternatively, in the range of about 80:20 to about 30:70; alternatively, 70:30 to 40:60; alternatively, about 60:40 to about 50:50; alternatively between greater than 100:0 and less than or equal to 51:49.

The specific examples provided in this disclosure are given to illustrate various embodiments of the invention and should not be construed to limit the scope of the disclosure. The embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### EXAMPLES

Synthesis of Pre-Lithiated Lithium Manganese-Based Oxide Product—The pre-lithiated lithium manganese-based oxide product as described in FIG. 4 was prepared by mixing together at total of 4.0 grams of LiMn₂O₄, 0.934 grams of LiOH*H₂O, and 2.74 grams of KOH. Since all of these materials are solids in nature at room temperature the mixing together involved grinding the materials together until they were thoroughly mixed. The ratio of the LiMn₂O₄ to LiOH*H₂O utilized in this example is 1.0, while the ratio of the lithium salt to KOH is about 0.45. As shown in FIG. 3, at a molar ratio of LiOH*H₂O to KOH of 0.45 or a mass ratio of KOH/(KOH+LiOH) of 0.75 at least a portion of the lithium salt is melted at a temperature above 226° C. with the entire lithium-potassium salt system becoming a liquid at a temperature of about 290° C. or more.

The mixture was then heated in flowing NH₃ at 350° C. overnight (˜10 hours) to form the pre-lithiated LiMn₂O₄. After cooling the pre-lithiated LiMn₂O₄ down to room temperature, the brownish or greenish powder was soaked in water for several minutes and then collected by filtering, rinsing with additional water, and finally drying in an oven. The dried powder was characterized by measuring the x-ray diffraction (XRD) pattern (see FIG. 4).

Preparation and Testing of an Electrode with Pre-Lithiated Lithium Manganese-Based Oxide Product—To make a pre-lithiated electrode, a composition comprising 97 wt. % of the pre-lithiated active cathode powders (Li₁₊ₓMn₂O₄) prepared above, 1.5 wt. % carbon nanotubes (CNT), and 1.5 wt. % polyvinylidene fluoride (PVDF) was formed by mixing the components together to form a mixed composition. This mixed composition was then coated onto an aluminum foil and calendared to form an electrode. Thus, the coated electrode comprised a mass ratio of active material/CNT/PVDF of 97/1.5/1.5.

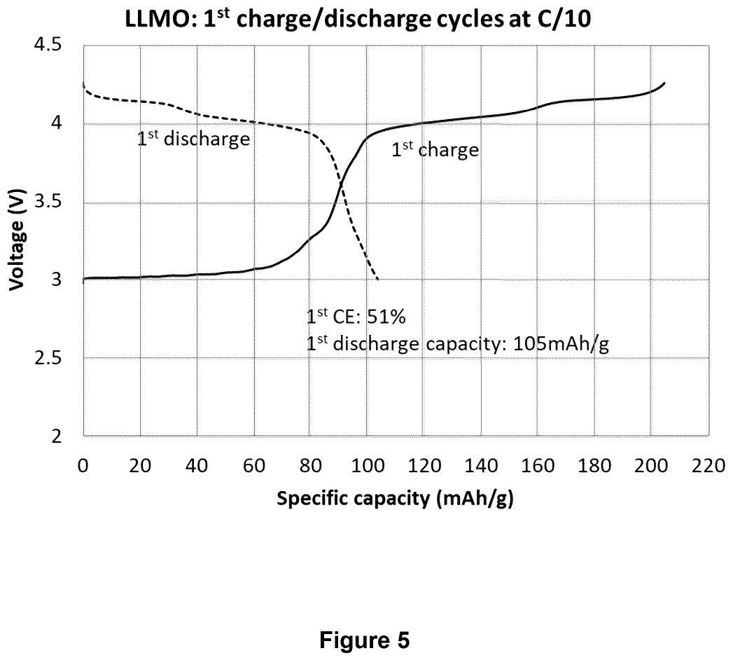

The coated electrode was then tested in an “anode-free” single-layer pouch cell against a Cu foil wherein the voltage ranged from 3.0 V to 4.25 V at about C/10. The cell was clamped together with two clips. The charge/discharge curves at the 1^{st} cycle for the cell containing the pre-lithiated electrode was measured and the 1^{st} Coulombic Efficiency (CE), as well as the 1^{st} discharge capacity determined. Referring now to FIG. 5 the 1^{st} Coulombic Efficiency (i.e., CE) of the coated electrode was 51%, and the 1^{st} discharge capacity was about 105 mAh/g. The low CE is expected for an electrode containing pre-lithiated LiMn₂O₄.

During operation, it is desirable that the Coulombic or current efficiency and the discharge capacity exhibited by the battery remains relatively constant. The Coulombic efficiency describes the charge efficiency by which electrons are transferred within the battery. The discharge capacity represents the amount of charge that may be extracted from a battery. As used herein, Coulombic Efficiency (CE) is defined as the ratio of the discharge capacity (mAh/g) to the charge capacity (mAh/g). For each electrode, the CE is generally less than 100%, in particular, for the 1^{st} charge/discharge cycle because of irreversible capacity loss that occurs due to the occurrence of side reactions. The 1^{st} cycle CE of an “anode-free” cell using these pre-lithiated cathode active materials may be <100%, alternatively, <90%; alternatively, <80%; alternatively, <70%; alternatively, <60%; and alternatively, about 50% as controlled by the amount of the lithium incorporated into the active cathode materials via the use of the pre-lithiation reaction. In this present disclosure, a lower 1^{st} cycle CE, corresponds to an increase in the amount of lithium added or deposited within the structure of the active cathode material.

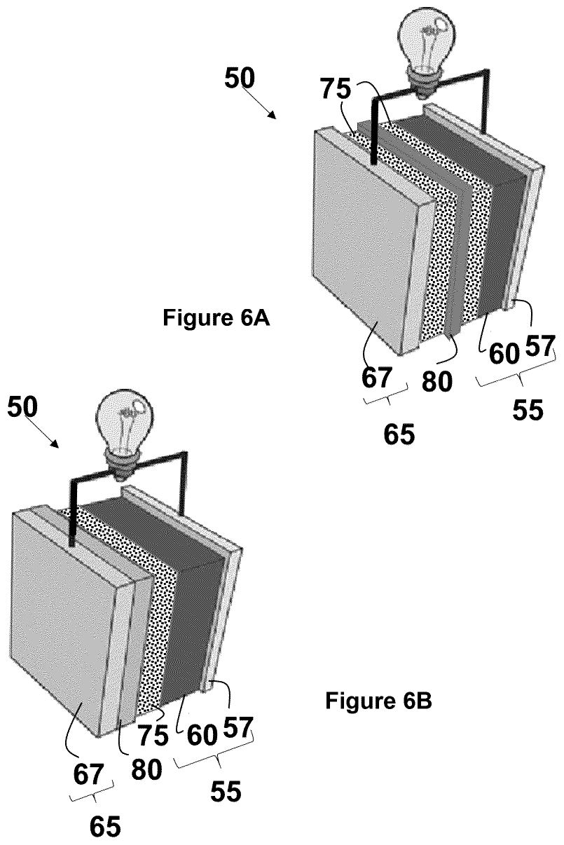

According to another aspect of the present disclosure, an energy storage device, such as a rechargeable battery cell, is provided that utilizes the pre-lithiated lithium manganese-based oxide product prepared according to the process described above as a cathode active material. One example of an energy storage device is a rechargeable lithium cell that includes an “anode-free” design as shown in FIGS. 6A and 6B. In an anode-free design, the rechargeable lithium cell 50 is made with a positive electrode 55 comprising a current collector 57 and an active material (cathode) 60, i.e., the pre-lithiated lithium manganese-based oxide product, while the negative electrode 65 side of the cell 50 generally includes only a current collector 67. A main benefit associated with an “anode-fee” cell is that it eliminates or at least significantly reduces the electrode volume and/or mass by not incorporating any pre-deposited anode active layer onto the current collector during the fabrication of the cell.

Still referring to FIGS. 6A and 6B, the “anode-free” cell further includes a separator 80 and an electrolyte 75 that supports the reversible flow of lithium ions between the positive electrode 55 and the negative electrode 65. The separator 80 is placed between the positive electrode 55 and negative electrode 65, such that the separator 80 separates the electrodes. The separator 80 is permeable to the reversible flow of lithium ions there through. The flow of ions may be conducted by the separator (i.e., via a solid-state mechanism) or by the presence of a liquid electrolyte 75 that permeates through the porosity of the separator 80 (e.g., a membrane).

The current collector 57 in the positive 55 electrode may be made of any metal known in the art for use in an electrode of a lithium battery, such as for example, without limitation, aluminum, titanium, stainless steel, nickel, copper, carbon, zinc, gallium, silver, and combinations or alloys formed therefrom. The current collector 67 used in the negative electrode 65 may be a metallic foil that does not react with lithium ions. Several examples of such metallic foils may include, but not be limited to, Cu, Fe, Ti, Ni, Mo, W, Zr, Mn, carbon, and lithium metal alloys. Alternatively, the metallic foil for the current collector 67 of the negative electrode 65 comprises Cu, Fe, Ni, or a mixture or alloy thereof.

As used herein a “battery cell” or “cell” refers to the basic electrochemical unit of a battery. In comparison, a “battery” or “battery pack” refers to a collection of cell(s), e.g., one or more cells, and includes a housing, electrical connections, and possibly electronics for control and protection.

According to yet another aspect of the present disclosure, one or more of the anode-free cells comprising the prelithiated active cathode material prepared according to the process of the present disclosure may be combined to form a larger capacity battery or battery pack, such as a lithium-ion secondary battery used in an electric vehicle (EV). The one or more cells may be incorporated in series, in parallel, or in a combination thereof in order to form the battery or battery pack. One skilled in the art will also appreciate that in addition to using the “anode-free” cells in a lithium-ion secondary battery, the same principles may be used to encompass or encase one or more cells into a housing for use in another application.

The housing may be constructed of any material known for such use in the art and be of any desired geometry required or desired for a specific application. For example, lithium-ion batteries generally are housed in three different main form factors or geometries, namely, cylindrical, prismatic, or soft pouch. The housing for a cylindrical battery may be made of aluminum, steel, or the like. Prismatic batteries generally comprise a housing that is rectangular shaped rather than cylindrical. Soft pouch housings may be made in a variety of shapes and sizes. These soft housings may be comprised of an aluminum foil pouch coated with a plastic on the inside, outside, or both. The soft housing may also be a polymeric-type encasing. The polymer composition used for the housing may be any known polymeric materials that are conventionally used in lithium-ion secondary batteries. One specific example, among many, include the use of a laminate pouch that comprises a polyolefin layer on the inside and a polyamide layer on the outside. A soft housing needs to be designed such that the housing provides mechanical protection for the “anode-free” cells present in the battery.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A process for the preparation of a pre-lithiated lithium manganese-based oxide product, the process comprising:
a) mixing together a lithium manganese-based oxide having a spinel crystal structure, a lithium salt, and potassium hydroxide (KOH) to form a mixture;
b) exposing the mixture to a predetermined temperature within the range of 226° C. to 450° C. in the presence of a reducing agent in order to form the pre-lithiated lithium manganese-based oxide product; wherein the reducing agent comprises ammonia (NH₃) and the amount of the lithium salt and the KOH present are in a ratio that results in at least a portion of the lithium salt being in a liquid state at the predetermined temperature;
c) removing the KOH from the pre-lithiated lithium manganese-based oxide product; and
d) collecting the pre-lithiated lithium manganese-based oxide product.

2. The process according to claim 1, wherein the pre-lithiated lithium manganese-based oxide product is defined according to the formula F-1
Li₁₊ₓMn_{2-y}A_{y}O₄, (F-1)
wherein x is within the range of 0<x≤1.0; y is within the range of 0≤y≤0.5; and A is a metal or a combination of metals, selected from the group consisting of Co, Cr, Fe, Ir, Mo, Ni, Pd, Pr, Rh, Ti, V, Ce, Tb, Ru, and Ta;
wherein the pre-lithiated lithium manganese-based oxide product comprises a spinel crystal structure.

3. The process according to claim 2, wherein when y>0 the metal or combination of metals, A, includes Ni, Co, or Cr.

4. The process according to claim 1, wherein the lithium manganese-based oxide having a spinel crystal structure in step a) is either LiMn₂O₄ or LiMn_{1.5}Ni_{0.5}O₄.

5. The process according to claim 1, wherein the lithium salt is LiOH and/or a hydrate thereof.

6. The process according to claim 1, wherein the lithium salt and the lithium manganese-based oxide used to form the mixture in step a) are present in a molar ratio of lithium manganese-based oxide:Li salt that is in range of about 1.0 to about 10.0.

7. The process according to claim 1, wherein one or more of the following is present:
the molar ratio of the lithium salt:KOH is in range of about 10.0 to about 0.1; and
the amount of the lithium salt and the KOH present are in a ratio that results in all of the lithium salt being in a liquid state at the predetermined temperature.

8. (canceled)

9. The process according to claim 1, wherein the temperature is at least 300° C.

10. The process according to claim 1, wherein the temperature ranges from about 350° C. to about 400° C.

11. The process according to claim 1, wherein the mixture is exposed to the temperature for a period of time that ranges from about 10 minutes to about 24 hours.

12. The process according to claim 1, wherein the reducing agent either comprises 100% ammonia by volume or comprises ammonia mixed with an inert gas in a volume ratio of NH₃ to inert gas that ranges from 5% to 95%.

13. (canceled)

14. The process according to claim 1, wherein collecting the pre-lithiated lithium manganese-based oxide product comprises filtering, washing, and drying the pre-lithiated lithium manganese-based oxide product.

15. The process according to claim 1, wherein removing residual KOH comprises exposing the pre-lithiated lithium manganese-based oxide product to an aqueous solution.

16. The process according to claim 14, wherein the pre-lithiated lithium manganese-based oxide product is dried at a temperature that ranges from about 110° C. to about 250° C. in air, an inert atmosphere, or under vacuum.

17. (canceled)

18. The process according to claim 1, wherein the lithium manganese-based oxide having a spinel structure is doped with at least one additional element in an amount that ranges from 0.1 wt. % to 1.0 wt. % relative to the overall weight of the lithium manganese-based oxide;
wherein the at least one additional element is selected from the group consisting of aluminum (Al), magnesium (Mg), calcium (Ca), boron (B), nitrogen (N), and fluorine (F).

19. An energy storage device having a positive electrode comprising a cathode active material that is at least partially formed of the pre-lithiated lithium manganese-based oxide product prepared according to claim 1.

20. The energy storage device according to claim 19, wherein the cathode active material is comprised entirely of the pre-lithiated lithium manganese-based oxide product.

21. The energy storage device according to claim 19, wherein the cathode active material further comprises one or more conventional cathode active materials selected from the group consisting of pristine LiMn₂O₄, LiFePO₄, LiFeₓMn_{y}PO₄ (i.e., x+y=1.0, 0.1≥x≤0.5, and 0.5≥y≤0.9), lithium nickel manganese cobalt oxides (NCM or Li-NCM), LiCoO₂, LiNi_{0.5}Mn_{1.5}O₄, and sulfur.

22. The energy storage device according to claim 21, wherein cathode active material comprises a mass ratio of the pre-lithiated lithium manganese-based oxide to the conventional cathode active material that ranges from about 99:1 to about 10:90.

23. A positive electrode for use in an electrochemical cell, the positive electrode comprising a cathode active material that is at least partially formed of the pre-lithiated lithium manganese-based oxide product prepared according to claim 1.
